(19) United States
(12) Patent Application Publication
(10) Pub. No.: US 2001/0039508 A1
(43) Pub. Date: Nov. 8, 2001

(54) Method and apparatus for scoring and matching attributes of a seller to project or job profiles of a buyer

(76) Inventors: Matthew Gordon Nagler, Fort Lee, NJ (US); Stephen David Sylwester, New York, NY (US); Felix Guruswamy, Somerset, NJ (US); Jayakumar Srinivasan, New York, NY (US); Martin Arthur Ahrens, Montclair, NJ (US)

Correspondence Address: THOMASON, MOSER AND PATTERSON L.L.P., 595 SHREWSBURY AVE, FIRST FLOOR, SHREWSBURY, NJ, 07702, US

(21) Appl. No.: 09/741,751

(22) Filed: Dec. 18, 2000

Related U.S. Application Data
(60) Provisional application No. 60/172,353, filed on Dec. 16, 1999.

(51) Int. Cl. G06F 17/60

(52) U.S. Cl. 705/11

(57) ABSTRACT

An apparatus and concomitant method to provide objective attributes scoring and matching between the attributes of a seller and the job requirements of a buyer. An objective overall rating for seller is generated that reflects the seller's degree of fit with a particular project or job profile of the buyer.

This application claims the benefit of U.S. Provisional application Ser. No. 60/172,353 filed on Dec. 16, 1999, which is herein incorporated by reference.

The present invention relates to an apparatus, system and concomitant method for scoring and matching the attributes of a seller or an applicant to the requirements of a project/job of a buyer or employer. Specifically, the present invention provides an objective attributes scoring engine that efficiently evaluates the attributes of an applicant as compared to the requirements of a project or job via a global set of interconnected computer networks, i.e., the Internet or World Wide Web.

### BACKGROUND OF THE DISCLOSURE

At any given time, numerous employers are seeking qualified applicants to fill numerous positions with very different requirements. The reverse situation is also true where at any given time, numerous applicants are seeking new employment opportunities. Unfortunately, such matching of skills of an applicant to a proper job profile has traditionally required great expense in terms of time and cost to the employer and applicant. A major obstacle is the need to objectively screen through a large amount of applicants to find a potential applicant that will match a specific job profile. Proper matching is critical for both parties. Namely, a mismatch of a potential candidate to a job often results in a very significant loss in time and resources for both the employer and the applicant.

To further complicate the problem, millions of people are learning to use the Internet in search of information and commerce. One advantage of the Internet is its flexibility and far reaching capability. An employer can now easily post a job listing that can be viewed by numerous applicants. Unfortunately, such broad reach of the Internet has also created problems. Namely, the Internet allows mass dissemination of information, where an employer may be inundated with hundreds or thousands of resumes that must be screened to determine which potential applicants will match possibly numerous available jobs with very different skills requirements. Thus, although the Internet has allowed an employer to reach many more potential candidates, it has also increased the complexity of the skills matching effort many fold.

Therefore, a need exists in the art for an apparatus and concomitant method to provide objective attributes scoring and matching between the skills of a seller and the job requirements of a buyer.

### SUMMARY OF THE INVENTION

In one embodiment of the present invention, an apparatus and concomitant method to provide objective attributes scoring and matching between the attributes of a seller and the job requirements of a buyer is disclosed. The apparatus can be implemented as an attributes scoring and matching service provider. Namely, an objective overall rating for the seller is generated that reflects the seller's degree of fit with a particular project or job profile of the buyer.

In brief, the seller's overall rating is derived from a plurality of seller attributes. These seller attributes include but are not limited to skills, education, certification, and experience. In turn, with respect to skills specifically, the seller's background is objectively separated into a plurality of knowledge elements. These knowledge elements, in turn, reflect the seller's background as to skills, roles and industry specific knowledge (herein Industries) that the seller possesses or has experienced.

In turn, a buyer's project or job position is similarly separated into a plurality of knowledge elements. By reducing the complex set of information of the seller's background (i.e., seller profile) and the complex set of information of the buyer's project or job (i.e., buyer profile) into a plurality of common measurable knowledge elements, the present method is able to quickly and efficiently compare a large number of seller profiles to buyer profiles to produce likely matches.

Additionally, not only is the seller's overall rating scored and matched for each job profile, the present invention also may provide a recommendation to the seller as to how to improve his or her chances for a particular job or project, e.g., by recommending a training course or program offered by a third party service provider.

In fact, inputs from third party service providers such as testing service providers, verification service providers and training service providers, can be received directly from these service providers by the present invention to further update the seller's overall rating. This and other functions of the present invention greatly improve the efficiency and accuracy of matching a seller's profile to a buyer's profile, thereby increasing the likelihood of the buyer and seller finding the most appropriate candidate and job, respectively.

### BRIEF DESCRIPTION OF THE DRAWINGS

The teachings of the present invention can be readily understood by considering the following detailed description in conjunction with the accompanying drawings, in which:

FIG. 1 depicts a block diagram of an overview of the architecture of the present invention for providing an objective attributes matching and scoring between the attributes of a seller and the job requirements of a buyer over a global set of interconnected computer networks, i.e., the Internet or world wide web;

FIG. 2 depicts a block diagram of a flowchart of the method of the present invention for providing an objective attributes matching and scoring between the attributes of a seller and the job requirements of a buyer;

FIG. 3 depicts a block diagram of a flowchart of the method of the present invention for generating the relevant attributes for a seller;

FIG. 4 depicts a block diagram of a flowchart of the method of the present invention for generating the knowledge elements for a buyer;

FIG. 5 depicts a block diagram of a flowchart of the method for generating an overall rating that is representative of the attributes scoring and matching of the present invention;

FIG. 6 illustrates a block diagram of a flowchart of the method for generating the skills match score of the present invention;

FIG. 7 illustrates a block diagram of a flowchart of the method for generating the education match score of the present invention;

FIG. 8 illustrates a block diagram of a flowchart of the method for generating the certification match score of the present invention; and

FIG. 9 illustrates a block diagram of a flowchart of the method for generating the experience match score of the present invention.

To facilitate understanding, identical reference numerals have been used, where possible, to designate identical elements that are common to the figures.

### DETAILED DESCRIPTION

The present invention is an apparatus, system and method that is designed to provide scoring and matching between the attributes of a seller and the job requirements of a buyer over a global set of interconnected computer networks, i.e., the Internet or world wide web. In one illustrative embodiment, the present invention is implemented as a attributes scoring and matching service provider that provides objective scores for sellers as applied to the job or project profiles of buyers.

The Internet is a global set of interconnected computer networks communicating via a protocol known as the Transmission Control Protocol and Internet Protocol (TCP/IP). The World Wide Web (WWW) is a fully distributed system for sharing information that is based upon the Internet. Information shared via the WWW is typically in the form of HyperText Markup Language (HTML) or (XML) “pages” or documents. HTML pages, which are associated with particular WWW logical addresses, are communicated between WWW-compliant systems using the so-called HyperText Transport Protocol (HTTP). HTML pages may include information structures known as “hypertext” or “hypertext links.” Hypertext, within the context of the WWW, is typically a graphic or textual portion of a page which includes an address parameter contextually related to another HTML page. By accessing a hypertext link, a user of the WWW retrieves the HTML page associated with that hypertext link.

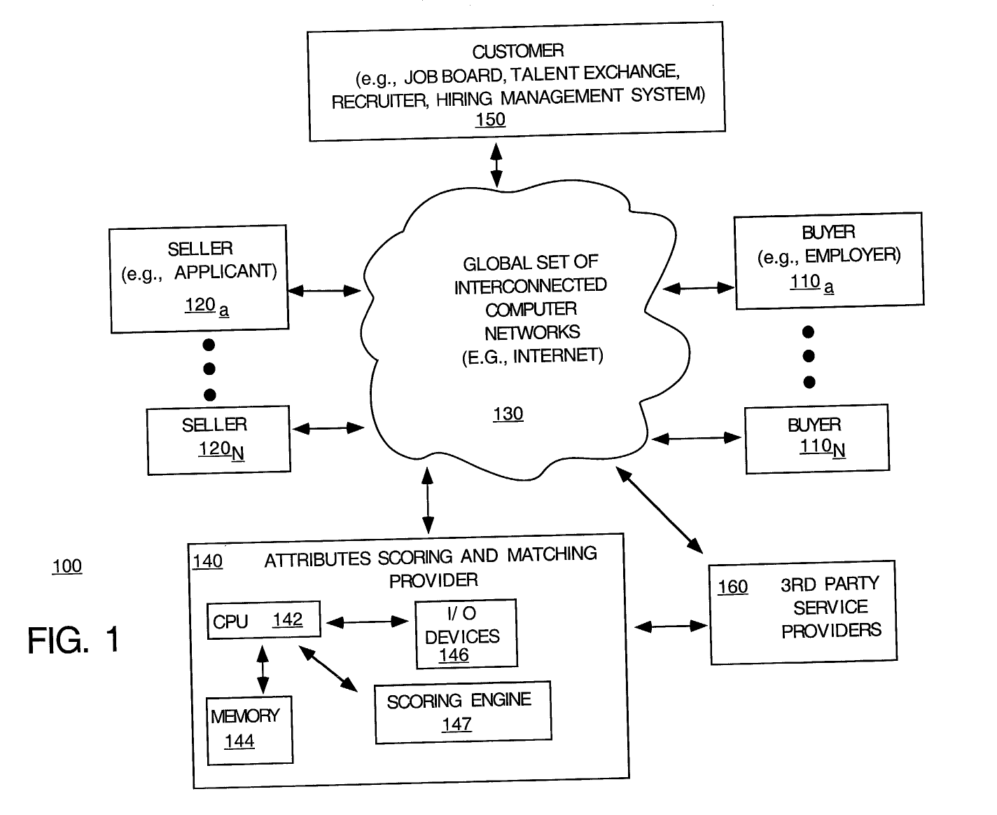

FIG. 1 depicts a block diagram of an overview of the architecture 100 of the present invention for providing attributes scoring and matching between the skills of a seller and the job requirements of a buyer over a global set of interconnected computer networks, i.e., the Internet or world wide web. The architecture illustrates a plurality of sellers 120a-n, a attributes scoring and matching service provider 140 of the present invention, a plurality of buyers 110a-n, a customer (e.g., job board, talent exchange, recruiter, hiring management system) 150 and third party service providers 160 that are all connected via the Internet 130.

In operation, the sellers 120a-n represent a plurality of job seekers with each job seeker having a particular set of attributes (e.g., skills, education, experience, certifications and training). The seller uses a general purpose computer to access the Internet for performing job searches and to submit personal information to various customers, buyers and the attributes scoring and matching provider 140 as discussed below.

Similarly, the buyers 110a-n represent a plurality of employers with each employer having one or more job positions that need to be filled. The buyer also uses a general purpose computer to access the Internet and to post available job positions and/or to submit the job positions to the customer 150. Specifically, the customer 150 may serve as an intermediary service provider, e.g., a recruiter or talent exchange, having a plurality of contacts with potential job seekers and employers. However, in order for the customer 150 or buyers 110a-n to effect a proper match between attributes of an applicant and a job profile, both entities must expend a large quantity of time and resources to manually evaluate and filter through a very large quantity of resumes and personal information. Such traditional skills matching method is tedious, subjective and time consuming.

To address this criticality, the present invention is deployed as an attributes scoring and matching service provider 140. Specifically, in one embodiment, the attributes scoring and matching service provider 140 can be a general purpose computer having a central processing unit (CPU) 142, a memory 144, and various Input/Output (I/O) devices 146. The input and output devices 146 may comprise a keyboard, a keypad, a touch screen, a mouse, a modem, a camera, a camcorder, a video monitor, any number of imaging devices or storage devices, including but not limited to, a tape drive, a floppy drive, a hard disk drive or a compact disk drive.

In the present invention, the attributes scoring and matching service provider employs an attributes scoring and matching engine 147 for scoring a potential applicant as applied against the job profiles of a buyer. The attributes scoring and matching engine 147 can be implemented as a physical device, e.g., as in an Application Specific Integrated Circuit (ASIC) or implemented (in part or in whole) by a software application that is loaded from a storage device and resides in the memory 144 of the device. As such, the scoring and matching service provider 140 and associated methods and/or data structures of the present invention can be stored on a computer readable medium.

In addition to performing the scoring and matching functions, the attributes scoring and matching provider 140 has the unique ability to interact with 3^{rd} party service providers 160 to effect the scoring of a potential applicant. For example, the 3^{rd} party service providers 160 can be a testing and assessment service provider, a verification and certification service provider or a training service provider. Thus, if an applicant is willing to undergo additional testing, training and certification, such additional information can be used to update an applicant's scoring. A detailed description of this feature is provided below.

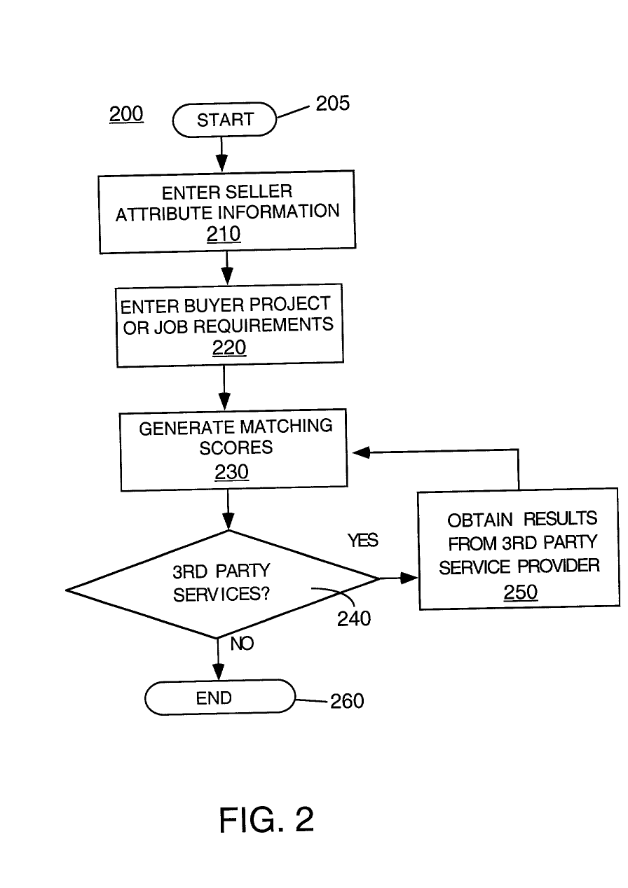

FIG. 2 depicts a block diagram of a top level flowchart of the method 200 of the present invention for providing an objective attributes matching and scoring between the attributes of a seller and the job requirements of a buyer. Method 200 starts in step 205 and proceeds to step 210, where method 200 allows a seller or applicant to provide various attribute information to a system, e.g., the attributes scoring and matching service provider 140 of FIG. 1. Such attributes information are stored and used below to ascertain a scoring for the seller as applied against a particular project or job position of a buyer.

In step 220, method 200 allows a buyer to define the requirements or profiles of a particular project or job position. This job profile is then employed as discussed below to match the attributes of potential sellers that are stored in a database to find the most appropriate candidates for the specified project or job.

In step 230, method 200 generates an “overall rating” or a match score based upon the stored seller and buyer information. It should be noted the overall rating generating step 230 can be generated based upon a request from a seller or a buyer. For example, once a seller has completed the input step of step 210, he can immediately request that an overall rating be generated against any currently available job positions that have yet to be filled as stored by the attributes scoring and matching service provider 140. Similarly, once a buyer has completed the input step of step 220, he can immediately request that an overall rating be generated against any currently available applicants that are available to be hired as stored by the attributes scoring and matching service provider 140.

In step 240, method 200 queries whether any 3^{rd} party services have been requested for a particular seller. For example, a seller may indicate that he is about to or has actually completed various tests that can be used to better reflect his current skills information, e.g., obtaining a Professional Engineering License. Alternatively, the seller may simply have asserted certain certifications and that the 3^{rd} party service provider has been contracted by the buyer or the attributes scoring and matching service provider 140 to verify such assertions made by the seller. In yet another alternate embodiment, the seller may indicate that he has recently completed certain training programs. A unique aspect of the present invention is that the scoring of a seller can be made to account for such 3^{rd} party information that is received independently from other resources other than from the seller.

Thus, if the query in step 240 is positively answered, then method 200 proceeds to step 250, where results from 3^{rd} party service providers are obtained and the seller's score is again updated in step 230. However, if the query in step 240 is negatively answered, then method 200 ends in step 260.

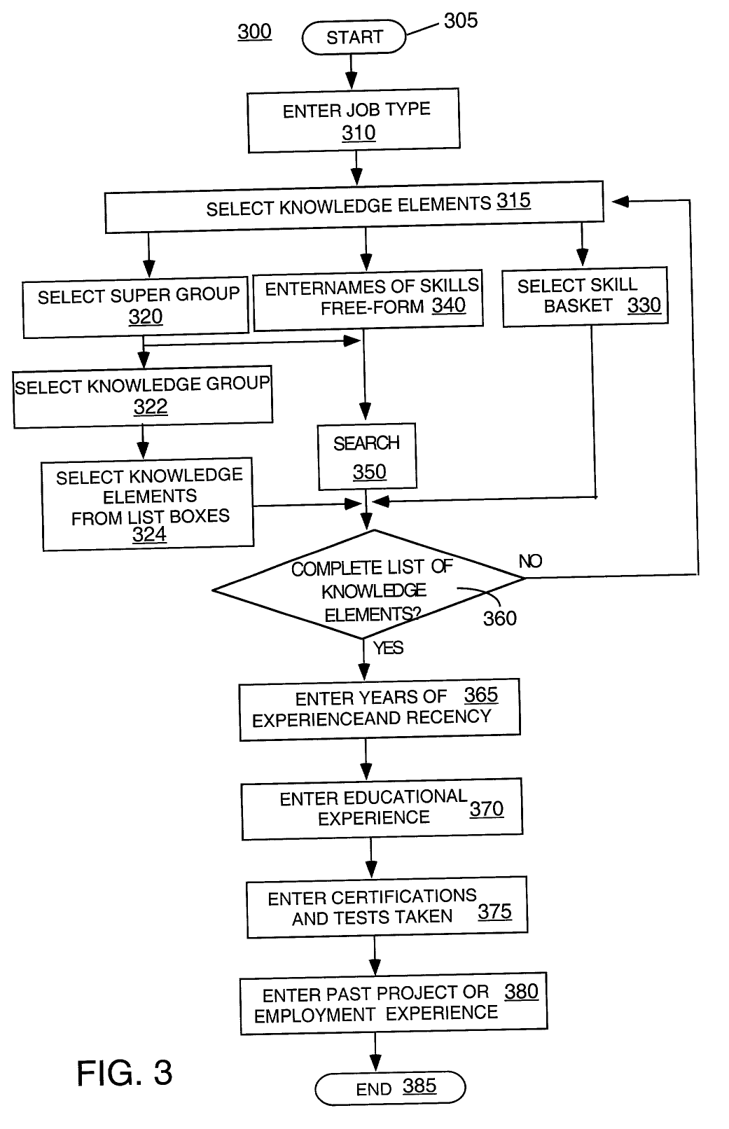

FIG. 3 depicts a block diagram of a flowchart of the method 300 of the present invention for generating the relevant attributes for a seller. Namely, seller enters information into a database describing his career- or knowledge-related background, capabilities, attributes, and interests. It should be noted that the “seller database” resides within a storage 146 of the attributes scoring and matching service provider 140.

Specifically, FIG. 3 illustrates the method 300 in which the skills and experience of a seller is broken down into a plurality of “knowledge elements”. Namely, method 300 is a detailed description of step 210 of FIG. 2. The process effectively separates the complex skills and experience of an applicant into a plurality of objective simplified elements or factors. The use of these knowledge elements will greatly simplify and produce a more accurate scoring and matching result.

Method 300 starts in step 305 and proceeds to step 310 where the seller selects a “Job type” that depicts the seller's area of career expertise, e.g., selecting a job type from a list or the seller can enter it in free-text form. For example, a standard job type may include but is not limited to, Patent Attorney, Obstetrics Nurse, Graphic Artist, Mechanical Engineer, Software Programmer and the like. Once a job type is selected, method 300 proceeds to step 315, where the seller specifically selects a plurality of knowledge elements from a proprietary skills taxonomy that best reflect his or her background and capabilities with three (3) separate options.

First, in step 320, method 300 will allow the seller to select a broad category or “Super Group” first to begin searching for the knowledge elements that one may possess for such a broad category. Examples of such broad “Super Groups” may include but are not limited to “Science”, “Medicine”, “Sports” and so on.

In step 322, method 300 will allow the seller to select a narrower “Knowledge Group” or subcategory under the Super Group. Examples of such “Knowledge Groups” may include but are not limited to “Chemistry”, “Biology”, “Physics” and so on for a super group of “Science”.

In step 324, method 300 provides a list of knowledge elements for each knowledge group that can be selected by the seller by simply checking the appropriate boxes or dragging them into a selected item box. Knowledge elements are grouped into several knowledge categories. Namely, each knowledge element is classified as one of three possible knowledge categories: 1) Skills; 2) Roles; and 3) Industries. “Skills” is a knowledge category that defines a knowledge element as a specific knowledge or capability of the seller, e.g., speaking a foreign language, writing software in a particular programming language and the like. “Roles” is a knowledge category that defines positions that were previously held by a seller, i.e., specific job or other roles held, e.g., a manager, a director, a vice president, a lab assistant, an intern and the like. Finally, “Industries” is a knowledge category that defines specific industry or market categories with which the seller may have developed experience, e.g., in-depth knowledge of the publishing industry, in-depth knowledge of venture capital sector, and the like. The application of these knowledge categories will be discussed below.

Alternatively, method 300 provides skills baskets in step 330 that can be selected as a bundle by the seller. Namely, the seller may select a standard skills basket consisting of those knowledge elements typically possessed by professionals in a given type of position. The system uses the Job Type selection that the seller made at step 310 to display the skills basket appropriate to the seller. The seller may select any, all, or none of the knowledge elements in the skills basket for inclusion in his profile.

In yet another alternative, method 300 allows the seller to enter in free-text form keywords representing knowledge elements possessed within a search tool of the attributes scoring and matching service provider 140. Namely, the seller can simply enter a word or a phrase that is then used in a search in step 350 to see whether the submitted word or phrase matches one or more knowledge elements. i.e., the method quickly finds knowledge elements using wild cards. Additionally, the search method is designed with “sounds like” technology that also recognizes there are alternative ways to type words referring to the same knowledge element. Since there are also common spelling errors, the present search algorithm also suggests to the seller some similar “sounding” knowledge elements. It should be noted that the search function can also be entered from the branch where the seller is selecting knowledge elements initially from the broad categories and subcategories after step 322.

In step 360, method 300 presents a list of selected knowledge elements that the seller has selected and queries whether the list of knowledge elements are complete. If the query is negatively answered, then method 300 returns to step 315 for additional knowledge elements. If the query is positively answered, then method 300 proceeds to step 365.

In step 365, method 300 allows the seller to provide information about his experience with each of the knowledge elements previously selected in terms of total years of experience with the element in question (via a drop down box showing a number of years) and its relative recency (via a drop down box with ranges in amount of elapsed time since elements were last used or experienced).

In step 370, method 300 allows the seller to provide information about his educational experience. Specifically, the seller describes multiple educational experiences, if any, usually college and graduate education. The elements may include but are not limited to: 1) Name of school (search tool is available to minimize number of key strokes by using a proprietary database of global educational institutions of the present invention), 2) Year graduated (e.g., standardized drop down boxes), 3) Major (drop down box, showing list of majors, from the proprietary databases), 4) Degree (drop down box, showing list of global degrees, from the proprietary databases), 5) Performance outcome (grade point average, etc.) and 6) Performance metric used by the school (drop down box, showing list of typical metrics from the databases).

In step 375, method 300 allows the seller to provide information about his certifications held or tests taken, if any. The elements may include but are not limited to: 1) Certifying organization (e.g., search tool is provided to minimize number of key strokes; by using the proprietary database of certifying institutions of the present invention), 2) Name of certification, 3) Date of certification, 4) Grade outcome of certification, if any, 5) Data accession number for certification, if any, thereby allowing the scoring and matching service provider 140 to have access to performance information directly from the Certifying Organization, when such a process is enabled. Additionally, the seller is also prompted for which knowledge elements previously selected by seller are supported by the Certification, especially, in those cases where this information is not already contained in the proprietary databases.

In step 380, method 300 allows the seller to provide information about past project and employment experiences. For each experience, the data elements may include but are not limited to: 1)Name of organization or client (free-form text), 2) Beginning and end date for the job or project engagement, 3) Level of commitment (e.g., full-time, part-time using drop down box), and 4) Team size worked with (drop down box). Additionally, seller is prompted for which knowledge elements, previously selected by the seller, were applied or experienced in the job or project. Method 300 then ends in step 385.

As discussed above, a unique aspect of the present invention is that the seller has the option to obtain third-party services from one or more of partners of the scoring and matching service provider 140. Namely, information in the seller's profile is acted upon by one of more third parties. The provided service results in supplemental information which then resides in the scoring and matching service provider's databases.

In fact, the scoring and matching service provider 140 may even suggest certain services offered by third parties that might enhance his profile and/or score as measured against a particular job position. Specifically, in generating the overall rating, the attributes scoring and matching service provider 140 gains insight into the attributes of the seller as applied to a particular job profile. Thus, the attributes scoring and matching service provider 140 may supply a recommendation as to how the seller's overall rating can be improved. For example, if a seller is missing a specified knowledge element, the attributes scoring and matching service provider 140 may recommend a training course that is being offered by a third party service provider, where the missing knowledge element can be acquired from the training course.

However, if the seller selects verification services from a 3^{rd} party, the seller must enter additional information to support the verification process, e.g., 1) Name of supervisors or other contacts at past employers, 2) Address and other locating information for past employers. Since the seller must make arrangements to pay for verification, the seller will also enter information about how he will pay for the verification services.

Since consent is necessary, the seller is also asked to grant permission to the attributes scoring and matching service provider 140 to use his “attributes profile” information for verification purposes. If the seller has consented to the use of his information, profile information of the seller is transferred to the third-party verification service provider (VSP). The VSP reviews each of the verifiable elements, and makes phone calls or other methods of contact to confirm or deny the validity of the seller information. This information may include but is not limited to: 1) School information: did the seller attend the claimed schools, pursue the claimed major, and receive the claimed degree and claimed grade; 2) Employer information: did the seller truly work for the claimed employer, for the claimed period, in the capacity claimed, and what were the departure conditions; 3) Certifications: did the seller receive the claimed certifications on the dates claimed and with the performance outcomes claimed and 4) criminal records verification and the like.

The VSP will transmit the results of the verification into the scoring and matching service provider's databases. The results of the verification are made available to the seller to the extent required by law. The results of the verification become part of the seller's profile.

Alternatively, if the seller selects third party testing services, e.g., a psychometric test, the seller is channeled through to a testing center of a partner or co-hosted site of the scoring and matching service provider 140. The seller's profile information comprising his relevant attributes is passed from the databases to the testing service provider (TSP) partner, so that appropriate tests may be recommended to the seller (e.g., related to his claimed knowledge elements). The seller selects tests that he would like to take and must make arrangements to pay for the testing.

After the testing, the TSP will transmit the results of the tests into the scoring and matching service provider's databases. The results of the tests are made available to the seller and become part of the seller's profile.

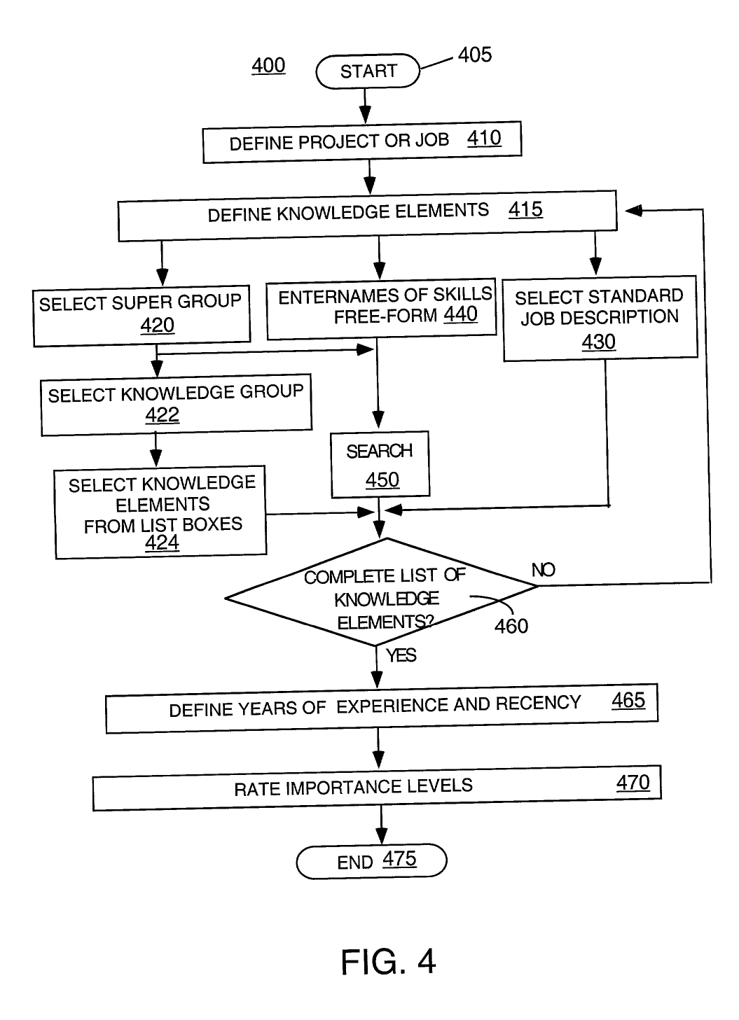

FIG. 4 depicts a block diagram of a flowchart of the method 400 of the present invention for generating the knowledge elements for a buyer. Namely, a buyer enters information into a database describing the requirements of a job or project. It should be noted that the “buyer database” also resides within a storage 146 of the attributes scoring and matching service provider 140.

Specifically, FIG. 4 illustrates the method 400 in which the requirements of a buyer are broken down into a plurality of “knowledge elements” needed or wanted by the buyer and other buyer specified requirements relating to the background of the seller. Namely, method 400 is a detailed description of step 220 of FIG. 2. With respect to the knowledge elements, the process effectively separates the complex requirements of a buyer into a plurality of objective simplified elements or factors. The use of these knowledge elements will greatly simplify and produce a more accurate scoring and matching result. It should be noted that the “knowledge elements” selection process for the Buyer is very similar to the knowledge element selection for the seller as discussed above in FIG. 3. This is important because the scoring engine 147 requires standardized data for an effective match score.

Method 400 starts in step 405 and proceeds to step 410 where the buyer defines a “Job Type” that the buyer needs to fill, e.g., defining a job type from a list or the buyer can enter it in free-text form. For example, a standard job type may include but is not limited to, Patent Attorney, Obstetrics Nurse, Graphic Artist, Mechanical Engineer, Software Programmer and the like. Once a job type is defined, method 400 proceeds to step 415, where the buyer specifically selects a plurality of knowledge elements from a proprietary skills taxonomy that best reflect the desired background and capabilities of a potential seller via three (3) separate options.

First, in step 420, method 400 will allow the buyer to select a “Super Group” first to begin searching for the knowledge elements that one may possess for such a broad category. Examples of such broad “Super Groups” may include but are not limited to “Science” or “Health”.

In step 422, method 400 will allow the buyer to select a narrower subcategory or a “Knowledge Group” under the Super Group. Examples of such “Knowledge Groups” may include but are not limited to “Chemistry” and “Physics” for a Super Group of “Science”.

In step 424, method 400 is designed to define a list of knowledge elements for each Knowledge Group that can be selected by the buyer by simply checking the appropriate boxes or dragging them into a selected items box.

Alternatively, method 400 provides standard job description in step 430 that can be selected as a bundle by the buyer. Namely, the buyer may select a standard job description consisting of those knowledge elements typically possessed by professionals in a given type of position. The system uses the Job Type selection that the buyer made at step 410 to display the standard job description appropriate to the buyer. The buyer may select any, all, or none of the knowledge elements in the standard job description for inclusion in his profile.

However, unlike the standard skills basket selected by the Seller in FIG. 3, the standard job description comes with knowledge elements already checked. The buyer simply un-checks those knowledge elements that are not desired instead.

In yet another alternative, method 400 allows the buyer to enter in free-text form keywords representing knowledge elements possessed within a search tool of the attributes scoring and matching service provider 140. Namely, the buyer can simply enter a word or a phrase that is then used in a search in step 450 to see whether the submitted word or phrase matches one or more knowledge elements. i.e., the method quickly finds knowledge elements using wild cards. Additionally, the search method is designed with “sounds like” technology that also recognizes there are alternative ways to type words referring to the same knowledge element. Since there are also common spelling errors, the present search algorithm also suggests to the buyer some similar “sounding” knowledge elements. It should be noted that the search function can also be entered from the branch where the buyer is selecting knowledge elements initially from the broad categories and subcategories after step 422.

As in the above case, “knowledge elements” are grouped into several knowledge categories. Namely, each knowledge element is classified as one of three possible knowledge categories: 1) Skills; 2) Roles; and 3) Industries. The application of these knowledge categories will be discussed below.

In step 460, method 400 presents a list of selected knowledge elements that the buyer has selected and queries whether the list of knowledge elements is complete. If the query is negatively answered, then method 400 returns to step 415 for additional knowledge elements. If the query is positively answered, then method 400 proceeds to step 465.

In step 465, method 400 allows the buyer to define information about the desired experience level with respect to each of the knowledge elements previously selected, e.g., the total number of years of experience associated with each of the knowledge elements in question (via drop down boxes showing ranges of number of years) and how recently the seller should last have had experience with the elements in question, i.e., its relative recency (via drop down boxes with ranges in amount of elapsed time since element should last have been used or experienced).

In step 470, method 400 allows the buyer to rate the importance of each of the knowledge elements previously selected. Specifically, the choices provided to the buyer are “Useful,” “Desired,” or “Required”. The rating choices are presented in standardized drop down boxes and their importance are described below. Method 400 then ends in step 475.

As in the case above, the buyer can optionally require that the sellers pass one or more third-party provided processes, e.g., certification or testing. Namely, the buyer can require sellers who wish to qualify for the job to obtain third-party provided services from one or more of the scoring and matching service provider's partners. For example, the buyer may require, as a pre-screening prerequisite for being scored against the job, that sellers have already obtained one or more services provided by a third party service providers. These may include verification of qualifications, testing and/or other third-party scoring-relevant services.

These requirements may result in qualified sellers passing processes that are identical to those described above with some exceptions. First, the requested service may be paid for by the buyer. If the buyer pays for the service, the results of the service generally are not displayed to the seller and do not become a part of the seller's profile

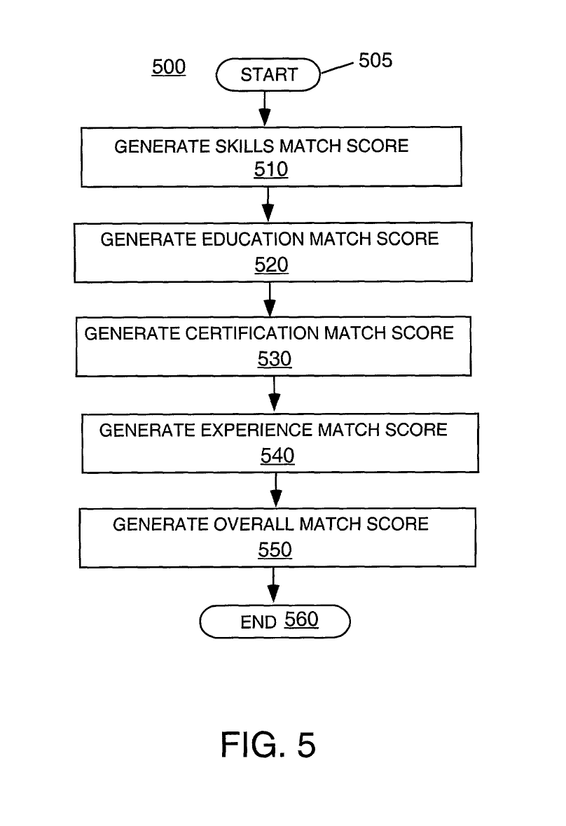

FIG. 5 depicts a block diagram of a flowchart of the method 500 for generating the overall rating that is representative of the attributes scoring and matching of the present invention. Specifically, a request from an outside party, a buyer, a seller, or the attributes scoring and matching provider 140 of the present invention will trigger the launch of the scoring method of FIG. 5.

It should be noted that although the present invention is disclosed below in generating an overall matching score that reflects a plurality of components of the candidate's background, i.e., the candidate's skills, the candidate's certifications, the candidate's education and finally the candidate's job experience, the present invention is not so limited. Namely, the overall score that is generated can be adapted to include fewer than the four listed components or for that matter to include other components using the same methods disclosed in the present specification.

It should be noted that the present invention provides enormous flexibility to all the parties who participate in the present attributes matching process. First, a buyer can selectively request that the scoring process be triggered to see a seller's score on a particular job position. Second, a buyer can obtain an initial assessment of its job profile to see how well matching scores are being generated. If too many applicants are matched, then the job profile can be tightened to reduce the list. Similarly, if too few applicants are matched, then the job requirements can be loosened to increase the list of matched applicants.

Similarly, a seller can request that the scoring process be triggered to see his match score against a particular job. This allows the seller to assess the likelihood of gaining the job position and may gain insight as to how to better his chances.

In addition, the attributes scoring and matching service provider can routinely launch the Scoring engine to score or re-score seller profiles against buyer job profiles, e.g., when the provider 140 changes elements of the scoring system, such as weights, parameters, algorithms, etc. In such an event, all existing seller profiles and buyer job profiles are queued to be re-scored. Other scenarios that may require re-scoring include the receipt of a new job profile or that an existing job profile is changed.

Returning to FIG. 5, method 500 starts in step 505 and proceeds to step 510, where a skills match score is generated. The skills match score matches the knowledge elements possessed by a seller as compared to the knowledge elements required for a particular buyer job.

In step 520, method 500 generates an education match score. The education match score matches the education background possessed by a seller as compared to the education background appropriate to or required for a particular buyer job.

In step 530, method 500 generates a certification match score. The certification match score matches the certification background possessed by a seller as compared to the certification background appropriate to or required for a particular buyer job.

In step 540, method 500 generates a job experience match score. The job experience match score matches the job experience background possessed by a seller as compared to the job experience background appropriate to or required for a particular buyer job.

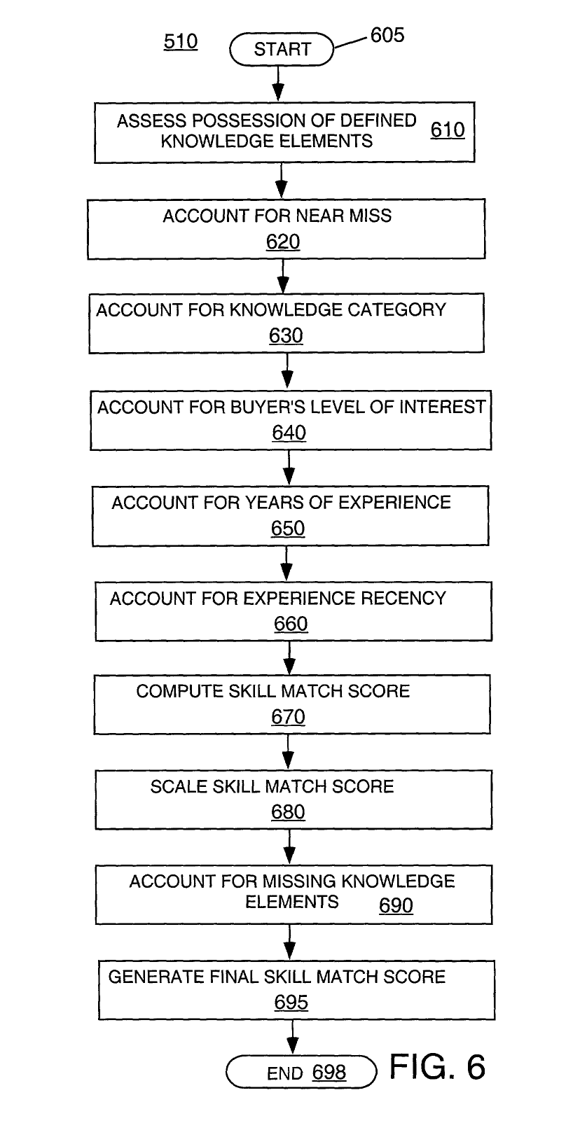

Finally, in step 550, the four match scores obtained in steps 510-540 are weighted to obtain an overall match score or an overall rating for the seller. Detailed descriptions of the calculations in obtaining these five match scores are provided below with reference to FIGS. 6-9.

Table 1 illustrates the use of the overall match score as a measure as to how close the seller matches a particular job position of the buyer. In one embodiment, the overall match score is calibrated between a score of 0 to 10, where a score of 10 for a seller indicates a highly qualified candidate and well matched for the job and a score of 0 for a seller indicates an unqualified candidate and not well matched for the job. However, it should be noted that the overall match score can be calibrated to other ranges, scales or units as well, e.g., 0-100% and the like.

TABLE 1

| Overall | Degree of | |
|---|---|---|
| rating | match | Match Score Description |
| 8.0-10.0 | Superior | Generally exceeds job requirements; |
| | | highly recommended, may be |
| | | “overqualified” |
| 5.0-8.0 | Excellent | Meets or nearly meets all job |
| | | requirements; highly recommended |
| 3.0-5.0 | Above Average | Meets reasonable share of |
| | | requirements; recommended |
| 0-3.0 | Standard | May not meet reasonable share of |
| | | requirements; not recommended |

FIG. 6 illustrates a block diagram of a flowchart of the method 510 for generating a skills match score of the present invention. Specifically, method 510 generates a match score that indicates the degree of fitness of the seller's skills as compared to the skills requirements of the buyer's job or project. To better understand the present attributes match score generating method, the reader is encouraged to consider Tables 2-6 below in conjunction with FIG. 6.

TABLE 2

| | | | | | Buyer | | | | |
|---|---|---|---|---|---|---|---|---|---|
| | | Seller | | Buyer | YrsWork/ | | Seller | | |
| | | Has/ | | Int | Recency | | YrsWork/ | | Weighted |
| KE | KC | NearMiss? | | level | Codes | | Recency | | match |
| 1 | 1 | 1 | 0 | 3 | 4 | 3 | 3 | 2 | 5.07 |
| 2 | 1 | 1 | 0 | 2 | 3 | 1 | 3 | 3 | 1.17 |
| 3 | 2 | 0 | .25 | 1 | 3 | 1 | 6 | 2 | .13 |
| 4 | 3 | 0 | .75 | 2 | 3 | 1 | 6 | 2 | .99 |

A brief description of Table 2 is now provided to assist the reader in understanding the skills match scoring method 510 as discussed below. Specifically, Table 2 illustrates an example of various pieces of information that are used by the current skills matching score method 510 in generating the skills match score for a seller. Column 1, entitled “KE”, identifies a list of knowledge elements, e.g., typing speed, knowledge of a foreign language, held position as a manager, and etc., that have been specified by a buyer for a particular job position.

Column 2, entitled “KC”, identifies a knowledge category associated with the corresponding knowledge elements. A listing of knowledge categories and their respective weights is provided in Table 3.

TABLE 3

| Knowledge | Knowledge | Knowledge Category |
|---|---|---|
| Categories | Category Codes | (KC) Weights |
| Skills | 1 | .6 |
| Roles | 2 | .2 |
| Industries | 3 | .2 |

Column 3 of Table 2, entitled “Seller Has/NearMiss” identifies whether the seller has the specified knowledge element for each row of Table 2. If the seller has the specified knowledge element, a value of “1” is assigned in Column 3, otherwise a “0” is assigned. However, even if the seller does not have the exact knowledge element, but instead possesses a very similar knowledge element, then a Near Miss value is assigned instead ranging from 0.01 to 0.99 in the second split column of column 3. One important aspect of the present invention is that it accounts for near miss knowledge elements. The basis is that certain knowledge elements have similar attributes such that some level of equivalence can be drawn.

Column 4, entitled “Buyer Int level”, identifies the level of interest by the buyer as to each knowledge element, e.g., a high typing speed may be required for a secretary, whereas it may only be considered useful for a sale representative position. A listing of Buyer's level of interest categories and their respective weights is provided in Table 4.

TABLE 4

| | | Buyer's level of |
|---|---|---|
| Buyer's level of | Buyer's level of | interest (BIL) |
| interest | interest Codes | Weights |
| Useful | 1 | 2 |
| Desired | 2 | 5 |
| Required | 3 | 15 |

Column 5, entitled “BuyerYrsWork/Recency”, identifies the number of years of work experience and experience recency associated with each knowledge element as specified by the buyer. For example, a buyer may specify for a knowledge element, e.g., managerial experience, that five (5) years of experience is desired and that such managerial experience should have been within the last two (2) years. It should be noted that the numeral values in Column 5 represent codes. These codes can be translated using Tables 4a and 4b below.

TABLE 4a

| Years of experience codes | Years of experience | |
|---|---|---|
| 1 | <1 | year |
| 2 | 1-2 | years |
| 3 | 2-4 | years |
| 4 | 4-6 | years |
| 5 | 6-10 | years |
| 6 | 10+ | years |

TABLE 4b

| Recency codes | Recency in years |
|---|---|
| 1 | current |
| 2 | within last year |
| 3 | within last 2 years |
| 4 | within last 4 years |
| 5 | no preference |

Thus, a value of “4” and “3” are entered into the split columns of column 5 in Table 2.

Column 6, entitled “SellerYrsWork/Recency”, identifies the number of seller's years of work experience and experience recency associated with each knowledge element as specified by the buyer. For example, a seller may have three of the five years of managerial experience and that managerial experience was only within the last year. It should be noted that the numeral values in Column 6 represent codes. These codes can be translated using Tables 4a and 4b above. Thus, a value of “3” and “2” are entered into the split columns of column 6 in Table 2.

Column 7, entitled “Weighted matches”, identifies the weighted score for each knowledge element. In turn, an overall skills match score is derived from the plurality of the weighted matches. The calculation of the weighted matches is described below with reference to FIG. 6.

Returning to FIG. 6, Method 510 starts in step 605 and proceeds to step 610 where method 510 assesses how many of the specified “knowledge elements” are possessed by the potential candidate. Using Table 2 as an example, knowledge elements 1 and 2 will be assigned the values of “1” to indicate the possession of those knowledge elements by the seller, whereas knowledge elements 3 and 4 will be assigned the values of “0” to indicate the lack of possession of those knowledge elements by the seller.

In step 620, method 510 accounts for near miss knowledge elements. Specifically, method 510 evaluates whether the seller possesses any knowledge elements that have near-equivalent attributes to those missing knowledge elements specified by the buyer. Using Table 2 as an example, knowledge elements 3 and 4 are assigned the values of “0.25” and “0.75” to indicate the presence of near-equivalent knowledge elements possessed by the seller. It should be noted that a higher value indicates a higher degree of equivalence whereas a low value indicates a low degree of equivalence.

In step 630, method 510 accounts for the knowledge category of each knowledge element. Specifically, as discussed above, one important aspect of the present invention is the unique breakdown of the skills requirement into objective identifiable knowledge elements. The knowledge elements may include specific skills, roles and industries specific knowledge.

However, each knowledge element is not equivalent in terms of its contribution to the overall matching score. For example, having a particular specified skill may be more important than a specified role or vice versa depending on the particular job profile.

To illustrate, a buyer may desire a seller to have the skills of electrical engineering and the role of having been a senior engineer. Although both knowledge elements are specified for the job, they are not weighted equally. In one embodiment of the present invention as shown in Table 3, knowledge category, “Skill”, is weighted more heavily than the knowledge categories, “Role” and “Industries”. One illustrative perspective is that a seller having the fundamental specified skills is considered more important than the roles or industry specific knowledge held by the seller. Namely, skills can be perceived as the underlying inherent capability of the seller, whereas role and industry specific knowledge are subjected to other external forces, e.g., opportunity to work in the specified industry, upward opportunity in the corporate ladder of previous employment, and so on.

In operation, method 510 in step 630 will multiply the corresponding knowledge category weights against the values contained in the seller Has/Near Miss column. For example, the value “1” of knowledge element 1 is multiplied with the weight “0.6” on Table 3 to arrive to a knowledge category weighted value of “0.6”.

In step 640, method 510 accounts for the buyer's level of interest for each knowledge element. Again, a distinction is made based upon the level of the buyer's interest for each knowledge element. A highly desired knowledge element is weighted more heavily than a generally useful knowledge element. In operation, the buyer's level of interest weight from Table 4 is multiplied with the knowledge category weighted value. For example, the knowledge category weighted value of “0.6” of knowledge element 1 from the above example is now multiplied with the weight value of “15” to arrive at a buyer interest weighted value of “9”.

In step 650, method 510 accounts for the buyer's desired years of work experience for each knowledge element. Again, a distinction is made based upon the years of work experience specified by the buyer for each knowledge element. Meeting or exceeding the years of work experience specified by the buyer is weighted positively, whereas not meeting the years of work experience specified by the buyer is weighted negatively. Table 5 provides a list of weights based upon differential in years of work experience. For example, the buyer interest weighted value of “9” of knowledge element 1 from the above example is now multiplied with the weigh value of “0.49” to arrive at a years of work experience weighted value of “4.41”.

TABLE 5

| Differential in years | Differential in years of |
|---|---|
| of work experience | work experience Weights |
| 5 | 2.37 |
| 4 | 2.33 |
| 3 | 2.24 |
| 2 | 2.06 |
| 1 | 1.71 |
| 0 | 1 |
| −1 | .49 |
| −2 | .23 |
| −3 | .10 |
| −4 | .04 |
| −5 | .01 |

In step 660, method 510 accounts for the buyer's desired recency in years of work experience for each knowledge element. Again, a distinction is made based upon how recent is the desired years of work experience specified by the buyer for each knowledge element. Meeting or exceeding the “recency” of the work experience specified by the buyer is weighted positively, whereas not meeting the recency of the work experience specified by the buyer is weighted negatively. Table 6 provides a list of weights based upon recency differential in years of work experience. For example, the buyer years of work experience weighted value of “4.41” of knowledge element 1 from the above example is now multiplied with the weight value of “1.15” to arrive at a recency years of work experience weighted value of “5.07” (or a weighted match).

TABLE 6

| Recency Differential | Recency Differential in |
|---|---|
| in years of work | years of work experience |
| experience | Weights |
| 4 | 1.29 |
| 3 | 1.27 |
| 2 | 1.23 |
| 1 | 1.15 |
| 0 | 1 |
| −1 | .59 |
| −2 | .39 |
| −3 | .29 |
| −4 | .24 |

In step 670, method 510 computes a skills match score from a plurality of weighted matches from all the specified knowledge elements. For example, the weighted matches in column 7 of Table 2 are used to generate a single skills match score, i.e., a weighted average. The weighted average can be computed in accordance with:

$$skill match score = \frac{\sum weighted match}{\sum ( KC weight \times BIL weight )}$$

For the example, a skills match score in Table 2 is 7.36/13.4=0.567.

In step 680, the skills match score is optionally scaled in accordance with a value, e.g., an exponent value e. In one embodiment the exponent value e is set to a value of “0.2”. Specifically, the skills match score is raised to the exponent of “0.2” for scaling purposes. This adjustment is made to re-distribute the skills match scores which, except for exceptionally qualified sellers, range between 0 and 1, more toward the high end of that range, without disturbing the hierarchy of the scores. Thus, the scaled skills match score for the above example is 0.567^{0.2}=0.89.

It should be noted that the present invention discloses various scaling operations that are implemented for a particular implementation. Thus, such scaling operations can be changed or omitted optionally.

In step 690, method 510 accounts for certain “units” of missing required or desired knowledge elements. Namely, a penalty is assessed against the final skills match score for missing required and desired knowledge elements, but not for useful knowledge elements. In one embodiment, each instance of missing required or desired knowledge element is accrued respectively. For example, knowledge element 4 in Table 2 is considered as being one unit of missing desired element, since the seller is missing this desired knowledge element.

However, to temper the effect of this penalty, method 510 determines if there is a “best near miss” knowledge element for the missing knowledge element. Namely, method 510 looks to the second split column of column 3 in Table 2 and checks the value assigned for any near miss knowledge element. If the assigned near miss value is equal to or greater than 0.5, then the associated accrued unit of penalty is removed. Thus, since the knowledge element 4 in Table 2 has an assigned near miss value of 0.75 (which is greater than 0.5), the accrued unit will be removed even though the “desired” knowledge element 4 is missing from the seller's profile. Any accrued units of missing elements that are assessed in step 690 will be used in step 695 in the generation of the final skills match score.

In step 695, method 695 generates the final skills match score. Specifically, the adjusted skills match score in step 680 is scaled to the desired scale range of 0-10. For example, the adjusted skills match score of 0.89 for the above example is multiplied with a value of “8” to produce a final skills match score of 7.12. For this particular example, no penalty is assessed against the final skills match score for not having a desired knowledge element. The final skills match score can be expressed as:

Final skills match score=adjusted skills match score×8

(sum of missing required element penalty values×2)

(sum of missing desired element penalty values×0.75)

It should be noted that the use of the factors “2” and “0.75” in the penalty calculation demonstrates a greater penalty being assessed against the seller for missing “required” knowledge elements than for missing “desired” knowledge elements.

Method 510 ends in step 698, where the final skills match score is provided to method 500 to generate the overall match score in step 550 of FIG. 5. It should be noted that the various weights and factors that are employed in method 510 can be adapted or changed in accordance with different implementations of the present invention. In fact, one or more steps of method 510 can be optionally omitted for different implementations.

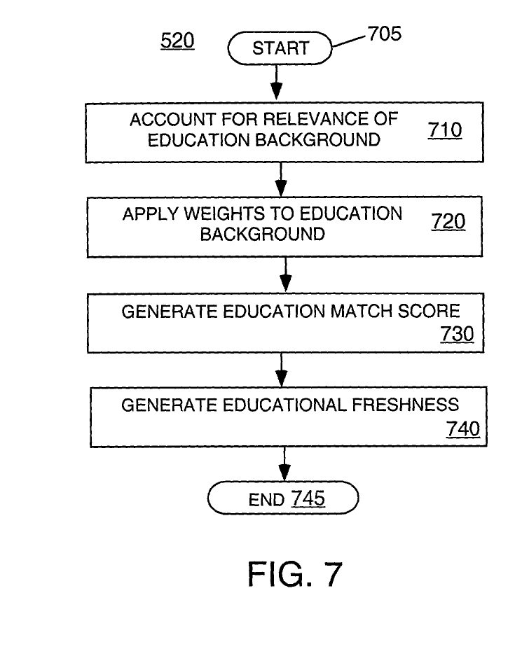

FIG. 7 illustrates a block diagram of a flowchart of the method 520 for generating an education match score of the present invention. Specifically, method 520 generates a match score that indicates the degree of fitness of the seller's educational background as compared to the specified knowledge elements of the buyer's job or project and/or what would be the most appropriate educational background for the job or project. To better understand the present educational match score generating method, the reader is encouraged to consider Table 7 below in conjunction with FIG. 7.

TABLE 7

| | | | | Match |
|---|---|---|---|---|
| Institution | Degree | Major | GPA | score |
| 10 | 7 | 8 | 7 | 8.32 |
| 8 | 8 | 9 | 8 | 8.22 |

A brief description of Table 7 is now provided to assist the reader in understanding the education matching score method 520 as discussed below. Specifically, Table 7 illustrates an example of the various pieces of information that are used by the current education matching score method 520 in generating the education match score for a seller. Each row of this Table represents a separate educational experience (e.g., degree) of the seller.

Column 1, entitled “Institution” contains a score that reflects the quality of the educational Institution attended by the seller. Namely, the score is a reflection of the generally-reputed quality of the Institution.

Column 2, entitled “Degree” contains a score that reflects the relevance and/or quality of the degree obtained by the seller. Namely, the score is a reflection of the quality and/or relevance of the degree as related to the knowledge elements defined by the buyer.

For example, a business degree might be assigned a value of “10” if the knowledge elements of a job include business oriented skills and roles, reflecting the degree's strong relevance to the knowledge elements of the job. On the other hand a business degree might be assigned a value of “3” if the knowledge elements of a job are related to engineering oriented skills and roles, which reflects the weak relevance to the knowledge elements of the job.

Column 3, entitled “Major” contains a score that reflects the relevance of the major studied by the seller. Namely, the score is a reflection of the relevance of the major as related to the knowledge elements defined by the buyer.

For example, an engineering major might be assigned a value of “10” if the knowledge elements of a job are related to engineering oriented skills and roles, reflecting the major's strong relevance to the knowledge elements of the job. On the other hand an engineering major might be assigned a value of “3” if the knowledge elements of a job are related to social work oriented skills and roles, which reflects the weak relevance to the knowledge elements of the job.

Column 4, entitled “GPA” (Grade Point Average) contains a score that reflects the actual overall GPA obtained by the seller at the Institution. It should be noted that the score for the GPA column also reflects a conversion that converts the original GPA scale to the present scale of 0-10, e.g., GPA scale of 0-4.0 are multiplied by a factor 2.5 and so on for other grade scales.

Column 5, entitled “Match score” contains the overall match score that reflects the relevance and/or quality of the entire educational background of the seller on a per experience basis. Thus, the example on Table 7 illustrates two separate match scores representative of two educational experiences of the seller.

In one embodiment of the present invention, the assignment of the values in columns 1-3 in Table 7 is performed using three look-up tables. The first look-up table contains a list of Degrees and their respective scores when compared against different knowledge groups. The second look-up table contains a list of Majors and their respective scores when compared against different knowledge groups. The third look-up table contains a list of Schools and their respective general reputation scores. These look up tables are provided in the Appendix.

Returning to FIG. 7, method 520 starts in step 705 and proceeds to step 710 where method 520 generates a value or score for each of the educational background components that accounts for quality and/or relevance of the educational background components as related to the knowledge elements defined by the buyer. In one embodiment, this is accomplished by use of look up tables.

In step 720, method 520 applies weighing process against the educational background components. Namely, a distinction is made between the importance of each of the educational background components, where the institution component generally has the greatest weight and the GPA has the least weight. For example, in one embodiment of the present invention, the institution component is raised to a power of “0.4”, the degree component is raised to a power of “0.25”, the major component is raised to a power of “0.25” and the GPA component is raised to a power of “0.1”. To illustrate, the educational components in the first row of Table 7 would be weighted as follows:

| | | |
|---|---|---|
| Institution | = 10⁴ | = 2.51 |
| Degree | = 7^{.25} | = 1.63 |
| Major | = 8^{.25} | = 1.68 |
| GPA | = 7^{.1} | = 1.21 |

In step 730, method 520 generates an overall education match score from the various educational background components. Specifically, all the educational components scores are multiplied together. To illustrate, the education match score for the first educational experience, e.g., the first row of Table 7, is 2.51×1.63×1.68×1.21=8.32.

However, as illustrated in Table 7, a seller may have multiple educational experiences. As such, if a seller has more than one educational experience, a maximum (max) function is applied to the plurality match scores on column 5 of Table 7. Thus, the final overall education match score for a seller in the example of Table 7 is simply 8.32, which is the highest match score between the two educational experiences.

In step 740, method 520 optionally computes the educational freshness parameter of the seller. Specifically, method 520 assesses the recency of the seller's educational experience in terms of months, but other time units can also be employed. The educational freshness parameter may be used as a weighing factor to affect the impact of the education match score on the overall match score. The basis of this weighing is that if the educational experience of the seller is many years ago, such “lack of freshness” can be used to reduce the impact of the education match score on the overall match score. The use of this educational freshness parameter is further discussed below.

Method 520 ends in step 745 where the final education match score is provided to method 500 to generate the overall match score in step 550 of FIG. 5. It should be noted that the various weights and factors that are employed in method 520 can be adapted or changed in accordance with different implementations of the present invention. In fact, one of more steps of method 520 can be optionally omitted for different implementations.

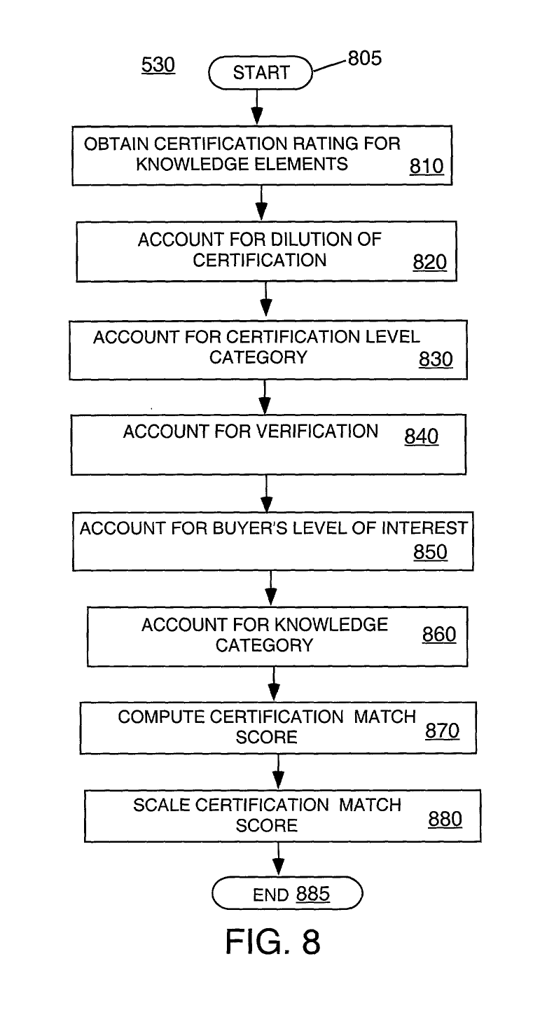

FIG. 8 illustrates a block diagram of a flowchart of the method 530 for generating the certification match score of the present invention. Specifically, method 530 generates a match score that indicates the degree to which the seller's certifications illustrate his qualifications with respect to the skills of the buyer's job or project. To better understand the present certification match score generating method, the reader is encouraged to consider Table 8 below in conjunction with FIG. 8.

TABLE 8

| | | | | | | Number of | | |
|---|---|---|---|---|---|---|---|---|
| | | | | | | skills or | | |
| | | Buy- | | | | knowledge | | |
| | | er | | Level | | or super | Ind. | |
| | | Int | Cert. | Cate- | | groups | cert | Line |
| KE | KC | level | Rating | gory | Verified | covered | score | score |
| 1 | 1 | 3 | 10 | 1 | 1 | 5 | 4.47 | 40.23 |
| 2 | 2 | 2 | 0 | — | — | — | — | 0 |
| 3 | 3 | 1 | 0 | — | — | — | — | 0 |
| 4 | 1 | 2 | 0 | — | — | — | — | 0 |

A brief description of Table 8 is now provided to assist the reader in understanding the certification matching score method 530 as discussed below. Specifically, Table 8 illustrates an example of the various pieces of information that are used by the current certification matching score method 530 in generating the certification match score for a seller. Column 1, entitled “KE”, identifies a list of knowledge elements, e.g., typing speed, knowledge of a foreign language, held position as a manager, and etc., that have been specified by a buyer for a particular job position.

Column 2, entitled “KC”, identifies a knowledge category associated with the corresponding knowledge elements. A listing of knowledge categories and their respective weights is provided in above in Table 3.

Column 3, entitled “Buyer Int level”, identifies the level of interest by the buyer as to each knowledge element, e.g., a high typing speed may be required for a secretary, whereas it may only be considered useful for a sale representative position. A listing of buyer's level of interest categories and their respective weights is provided above in Table 4.

Column 4, entitled “Cert Rating”, provides the generally-reputed quality level of the certification of the seller, if any, that relates to the job's knowledge element in question. The certification rating for the knowledge elements can be acquired from a look-up table. This look-up table is provided in the Appendix. There may be multiple such certifications of the seller; accordingly, various columns of Table 8, including column 4, would contain multiple split columns.

Column 5, entitled “Level Category”, identifies the level of the certification of the seller pertaining to the knowledge element in question.

Specifically, certifications can be separated into different categories of certification, i.e., 1) certification of the specific knowledge element (e.g., certified with respect to C++ programming), 2) certification of a knowledge group (e.g., certified to have passed the bar for an attorney or board exam for a physician) and 3) certification of a super group of knowledge (e.g., certified with respect to the broad field of health, without regard to specifically being a physician, nurse, dentist, etc.). In other words, a distinction is made as to at what level of specificity the specified knowledge elements are being certified. Generally, if the certification of a knowledge element is very specific to that knowledge element, then such certification is given more weight. However, if the certification of a knowledge element is not very specific to that knowledge element, then such certification is given less weight. A listing of certification levels and their respective weights is provided in Table 9.

TABLE 9

| Certification | Certification Level | Certification Level |
|---|---|---|
| Level | Code | (CL) Weight |
| Skills | 1 | 1 |
| Knowledge group | 2 | .328 |
| Super group | 3 | .05 |

Column 6, entitled “Verified”, identifies whether the seller's completion of the certification is verified or not verified. An assigned value of “1” indicates that the completion of the certification is verified and an assigned value of “0” indicates that the completion of the certification is not verified.

Column 7, entitled “Number Of Skills Or Knowledge or Super Groups Covered”, identifies how many certification level categories are covered by the certification event. As with the certification level itself, this will determine how specific the certification is to the knowledge element being certified. If the certification covers 5 skills, for example, typing, shorthand, stenography, reception, and phone technique, it will be given less weight as a certification of typing than will a certification that specifically covers typing alone.

Column 8, entitled “Ind. cert score”, identifies an individual certification score for each knowledge element, which are then converted into line score in Column 9. The calculation of the overall certification match score from the line scores is described below with reference to FIG. 8.

Returning to FIG. 8, method 530 starts in step 805 and proceeds to step 810 where method 530 assesses each of seller's “knowledge elements” to see whether there is a certification that the seller has that relates to the knowledge element. If such certifications do exist, method 530 will obtain the corresponding “certification rating” of those certifications from a look up table in one embodiment of the present invention. It should be noted that if no certification exists for a knowledge element of the seller, that particular knowledge element will receive a certification rating of zero, thereby causing the corresponding line score to be zero.

In step 820, method 530 accounts for dilution of the certification with respect to each knowledge element. Specifically, the dilution effect of a certification that certifies multiple elements will be accounted. For example, a broadly tailored certification that certifies numerous knowledge elements, knowledge groups, super groups (herein collective referred to as “certifiable elements”) will be weighted less for each of the knowledge elements certified by that certification. In contrast, a narrowly tailored certification that certifies very specific certifiable elements will be weighted greater for each of the certifiable elements being certified by that certification. In one embodiment, the certification rating obtained in step 810 will be divided by square root of the total number of certifiable elements certified by that certification. This can be illustrated as:

$$diluted certification rating = \frac{certification rating}{\sqrt{\# of certifiable elements certified by certification}}$$

For example, using the example above where the knowledge element of typing starts with a certification rating of 10 and is being diluted and where the certification actually certifies five (5) certifiable elements of typing, shorthand, stenography, reception, and phone technique, then the calculation is as follows:

$$diluted certification rating = \frac{10}{\sqrt{5}} = 4.47$$

It should be noted again that certifiable elements can include knowledge elements, knowledge groups and any super groups.

In step 830, method 530 accounts for the certification level with respect to each knowledge element. Specifically, if the certification is specific to a knowledge element, as opposed to a knowledge group or super group, then a greater weight is applied. Thus, the corresponding weights based on certification level category are used in accordance with Table 9 above. Namely, the CL weight is multiplied with the diluted certification rating in step 820.

To illustrate, using the above example, if the certification level is considered to be a skill, i.e., with a corresponding certification level weight of “1”, then the CL weight is obtained by multiplying the diluted certification rating of “4.47” with the weight 1 to arrive at the CL weighted rating of “4.47”.

In step 840, method 530 accounts for whether the certification is verified. If the certification has been verified, then no adjustment is made to the CL weighted rating in step 830. However, if the certification cannot be verified, then an adjustment is made to the CL weighted rating in step 830 by multiplying it by an adjustment factor. In one embodiment, the adjustment factor is expressed as:

$${.8}^{. \frac{1}{2}}$$

The result of the calculation of step 840 is a score relating to each certification relating to the knowledge element in question. The maximum (max) across these certifications becomes the individual certification score in column 8, of Table 8 for a particular knowledge element. Namely, method 530 takes the highest “verified CL adjusted rating” to be the individual certification score for a knowledge element, if multiple certifications exist for that knowledge element.

In step 850, method 530 accounts for the buyer's level of interest for each knowledge element. Again, a distinction is made based upon the level of the buyer's interest for each knowledge element. For a highly desired knowledge element, greater weight is applied to the individual certification score than for a generally useful knowledge element. In operation, the buyer's level of interest weights of Table 4 are multiplied by the individual certification score from step 840 to arrive at a BIL adjusted individual certification score.

In step 860, method 530 accounts for the knowledge category of each knowledge element. Namely, the KC weights of Table 3 will now be applied to the BIL adjusted individual certification score in column 9 of Table 8 to arrive at a line score. It should be noted that step 860 is similar to step 630 of FIG. 6 as discussed above.

In step 870, method 530 computes a certification match score from a plurality of line scores from all the specified knowledge elements. For example, the line scores in column 9 of Table 8 are used to generate a single certification match score, i.e., a weighted average. The weighted average can be computed in accordance with:

$$certification match score = \frac{\sum line scores}{\sum ( KC weight \times BIL weight )}$$

In step 880, method 530 optionally scales the certification match score in accordance with the formula listed below.

scaled cert. match score=cert. match score^{0.2}×10^{0.8}

As discussed above, this scaling operation is made to scale and re-distribute the certification match scores. It should be noted that the present invention discloses various scaling operations that are implemented for a particular implementation. Thus, such scaling operations can be optionally changed or omitted.

Method 530 ends in step 885, where the final certification match score is provided to method 500 to generate the overall rating score in step 550 of FIG. 5. It should be noted that the various weights and factors that are employed in method 530 can be adapted or changed in accordance with different implementations of the present invention. In fact, one of more steps of method 530 can be optionally omitted for different implementations.

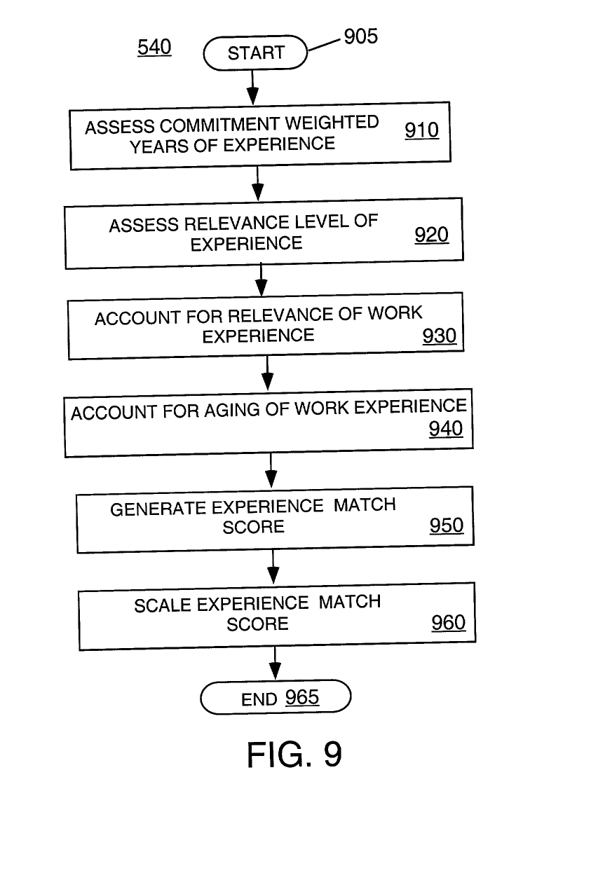

FIG. 9 illustrates a block diagram of a flowchart of the method 540 for generating the experience match score of the present invention. Specifically, method 540 generates a match score that indicates the depth of the seller's experience and its degree of fitness as compared to the knowledge elements of the buyer's job or project. To better understand the present experience match score generating method, the reader is encouraged to consider Table 10 below in conjunction with FIG. 9.

TABLE 10

| | Duration | | | | Relevance | |
|---|---|---|---|---|---|---|
| Employer | Start/End | | CLC | CWYE | level | RWYE |
| 1 | 1/1/94 | 12/31/98 | 2 | 4 | 1.11 | 4.44 |
| 2 | 1/1/99 | 12/31/99 | 2 | 1 | 0.98 | 0.98 |
| 3 | 2/1/00 | 8/31/00 | 2 | 0.5 | 0.7 | 0.35 |

A brief description of Table 10 is now provided to assist the reader in understanding the experience matching score method 540 as discussed below. Specifically, Table 10 illustrates an example of the various pieces of information that are used by the current experience matching score method 540 in generating the experience match score for a seller. Column 1, entitled “Employer”, identifies a list of employers that the seller has previously worked for.

Column 2, entitled “Duration Start/End”, identifies a start date and an end date for each employment experience. The data in this column will be used to determine the duration of each employment experience of the seller.

Column 3, entitled “CLC” (Commitment Level Code), identifies the level of commitment in terms of time expended by the seller as to each work experience, e.g., full time, part time and so on. A listing of possible seller commitment levels for one potential implementation and the respective weights on each is provided below in Table 11.

TABLE 11

| Commitment Levels | Commitment | Commitment Levels |
|---|---|---|
| Categories | Levels Codes | (CLW) Weights |
| More Than Full Time | 1 | 1.25 |
| Full Time | 2 | 1.0 |
| Part Time-1 day/week | 3 | .2 |
| Part Time-2 days/week | 4 | .4 |
| Part Time-3 days/week | 5 | .6 |
| Part Time-4 days/week | 6 | .8 |
| Other | 7 | 1.0 |

Column 4, entitled “CWYE” (Commitment-weighted years of experience), identifies the commitment level-weighted years of experience of the seller in each work experience. The calculation of the CWYE from the first three columns is described below with reference to FIG. 9.

Column 5, entitled “Relevance Level,” identifies the relevance level of each work experience of the seller relative to the knowledge elements of the buyer's job. The calculation of Relevance Level is described below with reference to FIG. 9.

Column 6, entitled “RWYE” (Relevance-weighted years of experience), identifies the relevance weighted years of experience of the seller in each work experience, and is calculated as the result in column 4 times the result in column 5.

Column 7, entitled “Aging Weight,” considers how many months ago is the end date of each of the seller's work experiences, and uses a look-up table to obtain a weight that will be applied to discount the work experience in question relative to other work experiences of the seller. Table 12 is used to obtain the aging weight:

TABLE 12

| Months Ago | Weights |
|---|---|
| 0-<6 | 1 |
| ≧6 | .95 |
| ≧12 | .90 |
| ≧24 | .85 |
| ≧36 | .8 |
| ≧60 | .75 |
| ≧120 | .70 |

Returning to FIG. 9, method 540 starts in step 905 and proceeds to step 910 where method 540 assesses the commitment weighted years of experience. In one embodiment, the commitment weighted years of experience (CWYE) can be expressed as:

$$CWYE = CLW \times \frac{end date - start date}{365}$$

Namely, method 540 takes each work experience in Table 10 and applies a corresponding CLW based upon the commitment level of the seller for that job experience.

In step 920, method 540 assesses the Relevance Level of each work experience of the seller. The seller has associated a set of knowledge elements from his profile with each work experience, by way of indicating that he has applied or experienced these knowledge elements on the job in that work experience. Each of these knowledge elements is compared with the knowledge elements of the job of the buyer, and each is given a rating of useful, desired or required based on the buyer's interest level in that knowledge element. If a knowledge element of the seller is not among the knowledge elements of the buyer's job, then that element receives a “no interest” rating. These “relevance ratings” receive associated experience interest level weights (EILWs) as described in Table 13 below. The EILWs are then averaged across all the knowledge elements that the seller applied in the work experience in question. The resultant average becomes the Relevance Level of the work experience. Namely, if seller had three (3) knowledge elements in one experience that correspond with buyer interest levels of 0, 2, and 3, then the relevance level for that experience is (0.6+1.3+1.43)/3=1.11.

TABLE 13

| Name | BuyIntLvl | EILW |
|---|---|---|
| No Interest | 0 | .60 |
| Useful | 1 | 1.0 |
| Desired | 2 | 1.3 |
| Required | 3 | 1.43 |

In step 930, method 540 accounts for the Relevance-Weighted Years of Experience (RWYE) by multiplying the Relevance Level obtained from step 920 by the CWYE from step 910.

In step 940, method 540 accounts for the aging of the work experience. Namely, if a work experience occurred many years ago, then a is weight is applied to reduce the effect of that experience relative to other experience due to its age. Namely, method 540 computes the number of months ago of the seller experience using the end date in column 2 of Table 10. The corresponding aging weight (AW) can then be obtained from Table 12, which is applied to the (RWYE) in a multiplication operation, i.e., AW×RWYE.

In step 950, method 540 generates the experience match score. In one embodiment, the product AW×RWYE of the first operation is summed across work experiences and weighted as follows:

$$TAWYE = \frac{\sum ( RWYE \times AW )}{\frac{\sum ( CWYE \times AW )}{\sum CWYE}}$$

The operation totals up all the work experience into a single match score. In essence, the TAWYE is the experience match score.

Additionally, it should be noted the TAWYE operation also includes an adjustment operation based on the aging weight. Namely, division by

$$\frac{\sum ( CWYE \times AW )}{\sum CWYE}$$

in step 950 is an adjustment operation that brings up the experience score,, whereas the first aging operating in step 940 brings down the experience score.

In step 960, method 540 scales the experience match score in accordance with Table 14 and an additional formula.

TABLE 14

| Wtd Months | Ratings |
|---|---|
| 0 | 0 |
| ≧1 | 1 |
| ≧2 | 1.5 |
| ≧4 | 2 |
| ≧6 | 2.5 |
| ≧9 | 3 |
| ≧11 | 3.5 |
| ≧14.5 | 4 |
| ≧18.5 | 4.5 |
| ≧23 | 5 |
| ≧29 | 5.5 |
| ≧36 | 6 |
| ≧44 | 6.5 |
| ≧52 | 7 |
| ≧61 | 7.5 |
| ≧84 | 8 |
| ≧90 | 8.5 |
| ≧120 | 9 |

Specifically, method 540 takes the result from step 950 and determines whether the rating is less than 10. If the query is positively answered, then method 540 will multiply the experience match score (EMS) from step 950 by “12” and use Table 14 to obtain a scaled experience match score. To illustrate, if the experience match score is “8”, then method 540 will multiple the score 8 by 12=96, which indicates a scaled experience match score of 8.5.

However, if the query is negatively answered, then method 540 will use the following formula:

$$scaled EMS = 9 + \frac{{2}^{( \frac{12 EMS}{40} - 3 )} - 1}{{2}^{( \frac{12 EMS}{40} - 3 )}}$$

It should be noted that the present invention discloses various scaling operations that are implemented for a particular implementation. Thus, such scaling operations can be optionally changed or omitted.

Method 540 ends in step 965, where the final experience match score is provided to method 500 to generate the overall match score in step 550 of FIG. 5. It should be noted that the various weights and factors that are employed in method 540 can be adapted or changed in accordance with different implementations of the present invention. In fact, one of more steps of method 540 can be optionally omitted for different implementations.

Finally, the overall “Seller match score” is computed in step 550 of FIG. 5. In one embodiment, each of the match scores from steps 510-540 is multiplied with a percentage where all the percentages add up to 100%.

The percentages can be expressed as:

Overall Seller match score=skill match score×70%

+education match score×10%

+certification match score×10%

+experience match score×10%

In an alternate embodiment, the effect of the education match score (EMS) is further affected by a freshness score. Namely, education experiences that are very old will be discounted. This discounting can be expressed as:

EMS′=EMS×(0.5+(1/20 freshness score))

where EMS′ would be substituted in the overall seller match score calculation for the education match score and where the freshness score has a scale between 0-10. Specifically, the freshness score is obtained in accordance with Table 15.

TABLE 15

| Age (in months) | Freshness score |
|---|---|
| 0-<17 | 10 |
| ≧17 | 9 |
| ≧35 | 8 |
| ≧47 | 7 |
| ≧59 | 6 |
| ≧70 | 5 |
| ≧81 | 4 |
| ≧94 | 3 |
| ≧110 | 2 |
| ≧133 | 1 |

Specifically, the freshness score is selected based upon how many months ago the education experience was completed. Thus, if freshness score is deemed to be important for a particular application, EMS′ will be used in the overall rating computation, instead of EMS.

It should be noted that the present invention describes numerous weight application steps, e.g., multiplication and division operations. As such, since the orders of these operations can be changed and yet still produce the same results, the teaching above and the claims below should be interpreted broadly as not limiting the present invention to a fixed sequence of operational steps.

Additionally, various tables are provided in the Appendix to assist the reader in understanding the present invention. However, it should be noted that these tables are provided as examples and that the present invention is not limited by the values or elements that are listed in these tables. Specifically, the values and elements can be adjusted in accordance with a particular implementation. In fact, elements can be omitted or new elements can be added, as necessary.

Although various embodiments which incorporate the teachings of the present invention have been shown and described in detail herein, those skilled in the art can readily devise many other varied embodiments that still incorporate these teachings.

### Appendix

Majors look-up table

| Knowledge Group Name | Major | Weight |
|---|---|---|
| Computer Operator | Computer Science | 10 |
| Wireline Voice Services | Computer Science | 8 |
| Translator | Computer Science | 7 |
| Paralegal | Computer Science | 7 |
| Retail Finance | Computer Science | 7 |
| Physician | Computer Science | 5 |
| Biology | Computer Science | 7 |
| Electrical Engineering/Electronics | Computer Science | 9 |
| Materials Science | Computer Science | 7 |
| Software/Office Automation | Computer Science | 8 |
| Sales | Computer Science | 7 |
| Computer/IT, Business Analyst | Computer Science | 10 |
| Computer/IT, Business Analyst | Business | 8 |
| Computer/IT, Business Analyst | Fine Arts | 4 |
| Computer/IT, Business Analyst | Accounting | 5 |
| Computer/IT, Business Analyst | Architecture/Design | 5 |
| Computer/IT, Business Analyst | Business Information | 9 |
| | Systems | |
| Computer/IT, Business Analyst | Education | 5 |
| Computer/IT, Business Analyst | Engineering | 7 |
| Computer/IT, Business Analyst | ---Agricultural Engineering | 6 |
| Computer/IT, Business Analyst | ---Ceramic Engineering | 7 |
| Computer/IT, Business Analyst | ---Chemical Engineering | 7 |
| Computer/IT, Business Analyst | ---Civil Engineering | 7 |
| Computer/IT, Business Analyst | ---Electrical Engineering | 8 |
| Computer/IT, Business Analyst | ---Electronics | 8 |
| Computer/IT, Business Analyst | Home Science | 4 |
| Computer/IT, Business Analyst | Language/Liberal Arts | 5 |
| Computer/IT, Business Analyst | ---Classics (Latin, Greek) | 5 |
| Computer/IT, Business Analyst | ---Communications | 5 |
| Computer/IT, Business Analyst | ---Ethnic Studies | 4 |
| Computer/IT, Business Analyst | ---French | 5 |
| Computer/IT, Business Analyst | ---Journalism | 4 |
| Computer/IT, Business Analyst | ---Literature | 4 |
| Computer/IT, Business Analyst | ---Mass Communications | 5 |
| Computer/IT, Business Analyst | ---Philosophy | 6 |
| Computer/IT, Business Analyst | ---Portuguese | 5 |
| Computer/IT, Business Analyst | ---Liberal Arts - Other | 5 |
| Computer/IT, Business Analyst | Law | 5 |
| Computer/IT, Business Analyst | Medicine | 4 |
| Computer/IT, Business Analyst | Nursing | 4 |
| Computer/IT, Business Analyst | Public Policy | 4 |
| Computer/IT, Business Analyst | Science/Mathematics | 6 |
| Computer/IT, Business Analyst | Social Science | 4 |
| Computer/IT, Business Analyst | ---Anthropology | 4 |
| Computer/IT, Business Analyst | ---Archeology | 4 |
| Computer/IT, Business Analyst | ---Economics | 6 |

Degrees look-up table

| Knowledge Group Name | Degree | weight |
|---|---|---|
| Business Analyst | --- BA | 7 |
| Business Analyst | --- MBA | 8 |
| Data Mining/Warehousing | --- BA | 7 |
| Database Admin | --- BA | 7 |
| Data Entry | --- BA | 7 |
| Web Admin | --- BA | 7 |
| Management | --- BA | 7 |
| Management | --- MBA | 9 |
| Network Engineer w/ | --- BA | 7 |
| WAN | | |
| Programmer Analyst | --- BA | 7 |
| Quality Assurance | --- BA | 7 |
| System Administrator | --- BA | 7 |
| Technical Writer | --- BA | 7 |
| Middleware | --- BA | 7 |
| Translator | --- BA | 7 |
| Operations | --- BA | 6 |
| Operations | --- MBA | 10 |
| Human Resources | --- BA | 6 |
| Lawyer | --- BA | 6 |
| Lawyer | --- JD/LLb | 10 |
| Expert Witness | --- PhD | 10 |
| Paralegal | --- BA | 7 |
| Strategic Planning & | --- BA | 6 |
| Development | | |

Schools look-up table

| University Name | College Name | Score |
|---|---|---|
| Bournemouth University | Media Arts and Communication | 4 |
| Trinity College | University of Dublin | 4 |
| University of Oxford | St Cross College | 10 |
| University of Oxford | St Edmund Hall | 10 |
| University of Oxford | St Hilda's College | 10 |
| University of Oxford | St Hugh's College | 10 |
| University of Oxford | St John's College | 10 |
| University of Oxford | St Peter's College | 10 |
| University of Oxford | Templeton College | 10 |
| University of Oxford | The Queens College | 10 |
| University of Oxford | Trinity College | 10 |
| University of Oxford | University College | 10 |
| University of Oxford | Wadham College | 10 |
| University of Oxford | Wolfson College | 10 |
| University of Oxford | Worcester College | 10 |
| University of Oxford | Wycliffe Hall | 10 |
| Universidad Austral | Universidad Austral | 6 |
| Universidad Nacional de San Juan | Universidad Nacional de San Juan | 4 |
| Universidad Nacional del Noreste | Universidad Nacional del Nordeste | 4 |
| Universidad Tecnologica Nacional | Universidad Tecnologica Nacional | 5 |
| Universidad Torcuato Di Tella | Universidad Torcuato Di Tella | 4 |
| Universidade de São Paulo | School of Business | 8 |
| Universidade de Sao Paolo | Instituto de Estudos Avancados | 7 |
| Universidade Castelo Branco | Faculdade de Direito | 3 |
| Universidade Catolica de Pernambuco | Universidade Catolica de | 6 |
| | Pernambuco | |
| Universidade de Brasilia | Universidade de Brasilia | 7 |
| Universidade de Fortaleza | Universidade de Fortaleza | 4 |
| Universidade de Sao Paulo | Universidade de Sao Paulo | 7 |
| Universidade do Amazonas | Universidade do Amazonas | 5 |
| Universidade do Estado do Rio de | Universidade do Estado do Rio de | 5 |
| Janeiro | Janeiro | |
| Universidade Estadual de Londrina | Universidade Estadual de Londrina | 5 |
| Universidade Estadual de Maringa | Universidade Estadual de Maringa | 5 |
| Universidade Estacio de Sao Paolo | Universidade Estacio de Sao Paolo | 5 |
| Universidade Federal de Minas Gerais | Universidade Federal de Minas | 6 |
| | Gerais | |
| Universidade Federal de Pelotas | Universidade Federal de Pelotas | 5 |
| Universidade Federal de Santa | Universidade Federal de Santa | 5 |
| Catarina | Catarina | |
| Universidade Gama Filho | Universidade Gama Filho | 5 |
| Universidade Regional Integrada | | 4 |
| Universidade So Judas Tadeu | | 4 |
| Centro de Ensino Unificado de Brasilia | | 4 |
| Centro de Estudos Superiores de | | 4 |
| Londrina (CESULON) | | |
| Escola de Administracao de Empresas | | 4 |
| de Sao Paulo | | |
| Escola Superior de Propaganda e | Escola Superior de Propaganda e | 7 |
| Marketing | Marketing | |
| Faculdade da Cidade | | 4 |
| Instituto de Pesquisas Cientificas e | | 4 |
| Tecnologicas | | |
| Pontificia Universidade Catolica de Sao | Pontificia Universidade Catolica de | 7 |
| Paulo | Sao Paulo | |
| Universidade Bandeirante de So Paulo | | 4 |
| Universidade Catolica de Brasilia | | 4 |
| Universidade Catolica de Pelotas | | 4 |
| Universidade Cidade de Sao Paulo | Universidade Cidade de Sao Paulo | 4 |
| Universidade de Cruz Alta | | 4 |
| Universidade de Mogi das Cruzes | Universidade de Mogi das Cruzes | 4 |
| Universidade Estadual de Campinas | | 4 |
| Universidade Estadual Paulista | Universidade Estadual Paulista | 5 |
| Universidade Estadual Paulista - | Universidade Estadual Paulista - | 5 |
| Campus de Guarati | Campus de Guarati | |
| Universidade Federal de Juiz de Fora | | 4 |
| Universidade Federal de Sao Paulo | | 4 |
| Escola Paulista | | |
| Universidade Federal de Vicosa | | 4 |
| Universidade Federal do Para | Universidade Federal do Para | 5 |
| Universidade Federal do Rio Grande do | | 4 |
| Sul | | |
| Universidade Ibirapuera | Faculdade de Direito | 5 |
| Universidade Presbiteriana Mackenzie | Universidade Presbiteriana | 7 |
| | Mackenzie | |
| University of South Florida | College of Nursing | 4 |
| University of Tampa | College of Business | 5 |
| University of West Florida | College of Business | 4 |
| Western Kentucky University (WKU) | Ogden College of Science, Technology | 4 |
| | & Health | |
| Zoe University | Zoe University | 2 |
| American Institute For Computer | | 1 |
| Science | | |
| Adrew College | | 2 |
| Asbury College | | 3 |
| Asbury Theological Seminary | | 2 |
| Ashland Community College | | 2 |
| Athens Area Technical Institute | | 2 |
| Athens State College | | 2 |
| Atlanta Christian College | | 2 |
| Atlanta College of Art | | 2 |
| Atlanta Metropolitan College | | 2 |
| Atlanta University Center | | 1 |
| Daytona Beach Community College | | 2 |
| DeKalb Technical Institute | | 2 |

Certifications look-up table

| Certification Name | Rating |
|---|---|
| Adobe Certified Training Provider (ACTP) | 10 |
| Microsoft Certified Solution Developer (MCSD) | 10 |
| Physical Medicine & Rehabilitation | 10 |
| Plastic Surgery within the Head and Neck | 10 |
| Radiology | 10 |
| Reproductive Endocrinology | 10 |
| Certified Nurse Midwife | 10 |
| ACRCME Certificate | 10 |
| First Aid and CPR Instructor | 10 |
| Adobe Certified Expert (ACE) Adobe Photoshop® 5.0 | 10 |
| Microsoft Certified Professional +Internet (MCP + I) | 9 |
| State Bar Admissions | 9 |
| State Bar Admissions | 9 |
| State Bar Admissions | 9 |
| Federal Circuit Court Admissions | 9 |
| IBM Certified Systems Expert - OS/2 Warp Server | 9 |
| Certificate/License - Series 27 Financial & Operations Principal | 9 |
| Certificate/License - Series 55 Equity Corporate Securities | 9 |
| Trader | |
| Registered Communications Distribution Designer (RCDD) | 8 |
| Cisco Certified Design Professional (CCDP) | 8 |
| Analytical Chemist - Level 4 | 8 |
| Eco-Audit Specialists | 8 |
| State Bar Admissions | 8 |
| Federal Circuit Court Admissions | 8 |
| US District Court Admissions | 8 |
| Senior Professional in Human Resources (SPHR) | 8 |
| Professional Standards | 8 |
| Civil Psychological Injury | 8 |
| Certified Midwife | 8 |
| Exercise Specialist | 8 |
| Advanced Cardiac Life Support (ACLS) | 8 |
| Certified Alcohol Counselor | 8 |
| Neuromuscular Therapy | 8 |
| Criminal Trial Certification | 8 |
| IBM Certified Advanced Technical Expert-IBM CS-AIX System | 8 |
| Support | |
| Certificate/License - Series 66 NASAA Uniform Combined | 8 |
| License | |
| Certified Expert (BNCE) | 7 |
| Cisco Certified Design Associate (CCDA) | 7 |
| Corel Certified Expert (CCE) | 7 |
| IBM Certified Solutions Expert | 7 |
| Microsoft Office User Specialist - Proficient level | 7 |
| Fellow of the Institute of Canadian Bankers (FICB) | 7 |
| Securities Analyst | 7 |
| STA Diploma | 7 |
| Concrete Field Testing Technician - Grade I | 7 |
| Act! 4.0 User | 7 |
| AOL User | 7 |
| Internet Explorer 4 User | 7 |
| MS Word 2000 User | 7 |
| Certified Technical Trainer (CTT) | 6 |
| Cisco Certified Internetwork Expert (CCIE) | 6 |
| IBM Certified Professional Server Specialist | 6 |
| Certified Professional Secretary | 6 |
| Fitness Instructor | 6 |
| Energy IK Analyst (U.S.) | 6 |
| IE 4 Administrator | 6 |
| Oracle 8 DBA | 6 |
| Windows NT Workstation Administrator | 6 |
| Developer Certification | 5 |
| California Real Estate License - Training | 5 |
| Staff Training | 5 |
| Real Estate License - Training | 5 |
| NASD Broker Licensing - Training | 5 |
| Diploma in Technical Analysis | 5 |
| Technical Analysis: Level 1 | 5 |
| Chartered Public Financial Accountant (CPFA) - Training | 5 |
| Foundations in Financial Planning (FFPN) - Training Certificate | 5 |
| Commodity Boot Camp | 5 |
| Fellow Credit Institute (FCI) | 5 |
| Associate in Claims (AIC) | 5 |
| Associate in Risk Management (ARM) | 5 |
| Certified Financial Planner Training | 5 |
| Certificate/License - Series 11 Assistant Representtive, Order | 5 |
| Processing | |
| Certificated Project Manager (CPM) | 4 |
| Diversified Cash Flow Specialist | 4 |
| Certified Lease Professional | 4 |
| Floor Trader (FT) | 4 |
| Futures Commission Merchant (FCM) | 4 |
| Introducing Broker (IB) | 4 |
| Banker Certification Program | 4 |
| Pediatric CPR | 4 |
| Optician N.C.L.C. | 4 |

What is claimed is:

1. A method for generating an overall rating that reflects the fitness of a set of seller's background information as compared to a set of buyer's job requirements, said method comprising the steps of:
a) reducing the set of seller's background information into a plurality of seller knowledge elements;
b) reducing the set of buyer's job requirements into a plurality of buyer knowledge elements;
c) applying one or more weights to at least one common knowledge element that is common between said plurality of seller knowledge elements and said buyer knowledge elements; and
d) generating the overall rating in accordance with said weighted at least one common knowledge element.

2. The method of claim 1, wherein said knowledge elements relate to a plurality of skills of the seller.

3. The method of claim 2, wherein said applying step c) applies a weight to said at least one common knowledge element in accordance with a knowledge category.

4. The method of claim 3, wherein said knowledge category comprises a skill, a role and an industry knowledge.

5. The method of claim 2, wherein said applying step c) applies a weight to said at least one common knowledge element in accordance with a buyer's interest level.

6. The method of claim 2, wherein said applying step c) applies a weight to said at least one common knowledge element in accordance with a buyer's desired years of experience.

7. The method of claim 2, wherein said applying step c) applies a weight to said at least one common knowledge element in accordance with a buyer's desired recency in years of experience.

8. The method of claim 1, wherein said knowledge elements relate to an educational background of the seller.

9. The method of claim 8, wherein said applying step c) applies a weight to said at least one common knowledge element in accordance with relevance of said educational background of the seller.

10. The method of claim 8, wherein said applying step c) applies a weight to said at least one common knowledge element in accordance with a type of educational background component of said educational background of the seller.

11. The method of claim 10, wherein said type of educational background component comprises an institution, a degree, a major and a grade point average (GPA).

12. The method of claim 1, wherein said knowledge elements relate to a certification of the seller.

13. The method of claim 12, wherein said applying step c) applies a weight to said at least one common knowledge element in accordance with a certification rating corresponding to said certification.

14. The method of claim 12, wherein said applying step c) applies a weight to said at least one common knowledge element in accordance with a dilution of certification.

15. The method of claim 12, wherein said applying step c) applies a weight to said at least one common knowledge element in accordance with a certification level.

16. The method of claim 12, wherein said applying step c) applies a weight to said at least one common knowledge element in accordance with a verification of the certification.

17. The method of claim 12, wherein said applying step c) applies a weight to said at least one common knowledge element in accordance with a buyer's level of interest.

18. The method of claim 12, wherein said applying step c) applies a weight to said at least one common knowledge element in accordance with a knowledge category.

19. The method of claim 18, wherein said knowledge category comprises a skill, a role and an industry knowledge.

20. The method of claim 1, wherein said knowledge elements relate to a work experience background of the seller.

21. The method of claim 20, wherein said applying step c) applies a weight to said at least one common knowledge element in accordance with a commitment level.

22. The method of claim 20, wherein said applying step c) applies a weight to said at least one common knowledge element in accordance with a relevance level.

23. The method of claim 20, wherein said applying step c) applies a weight to said at least one common knowledge element in accordance with an aging level.

24. The method of claim 1, wherein said knowledge elements relate to a plurality of skills, an educational background, a certification, and a work experience background of the seller.

25. The method of claim 1, further comprising the step of:
e) adjusting said overall rating in accordance with information provided by a third party service provider.

26. The method of claim 25, wherein said information provided by said third party service provider comprises verification information pertaining to the seller's background information.

27. The method of claim 25, wherein said information provided by said third party service provider comprises testing information pertaining to the seller's performance on a test.

28. The method of claim 25, wherein said information provided by said third party service provider comprises training information pertaining to the seller's completion on a training program.

29. The method of claim 1, wherein said knowledge elements comprise a skill possessed by the seller, a role held by the seller or an industry knowledge possessed by the seller.

30. The method of claim 1, wherein said applying step c) comprises the step of:
c1) assessing near miss knowledge elements.

31. The method of claim 1, further comprising the step of:
e) adjusting said overall rating in accordance with a freshness education level.

32. The method of claim 1, further comprising the step of:
e) adjusting said overall rating in accordance a penalty measure that correlates to an accruement of missing buyer knowledge elements.

33. An apparatus for generating an overall rating that reflects the fitness of a set of seller's background information as compared to a set of buyer's job requirements, said apparatus comprising:
means for reducing the set of seller's background information into a plurality of seller knowledge elements;
means for reducing the set of buyer's job requirements into a plurality of buyer knowledge elements;
means for applying one or more weights to at least one common knowledge element that is common between said plurality of seller knowledge elements and said buyer knowledge elements; and
means generating the overall rating in accordance with said weighted at least one common knowledge element.

34. The apparatus of claim 33, wherein said knowledge elements relate to a plurality of skills of the seller.

35. The apparatus of claim 33, wherein said knowledge elements relate to an educational background of the seller.

36. The apparatus of claim 33, wherein said knowledge elements relate to a certification of the seller.

37. The apparatus of claim 33, wherein said knowledge elements relate to a work experience background of the seller.

38. The apparatus of claim 33, wherein said knowledge elements relate to a plurality of skills, an educational background, a certification, and a work experience background of the seller.

39. The apparatus of claim 33, further comprising a means for adjusting said overall rating in accordance with information provided by a third party service provider.

40. The apparatus of claim 33, wherein said knowledge elements comprise a skill possessed by the seller, a role held by the seller or an industry knowledge possessed by the seller.

41. The apparatus of claim 33, wherein said applying means further assesses near miss knowledge elements.

42. The apparatus of claim 33, further comprising a means for adjusting said overall rating in accordance with a freshness education level.

43. The apparatus of claim 33, further comprising a means for adjusting said overall rating in accordance a penalty measure that correlates to an accruement of missing buyer knowledge elements.

44. A computer-readable medium having stored thereon a plurality of instructions, the plurality of instructions including instructions which, when executed by a processor, cause the processor to perform the steps comprising of:
a) reducing the set of seller's background information into a plurality of seller knowledge elements;
b) reducing the set of buyer's job requirements into a plurality of buyer knowledge elements;
c) applying one or more weights to at least one common knowledge element that is common between said plurality of seller knowledge elements and said buyer knowledge elements; and
d) generating the overall rating in accordance with said weighted at least one common knowledge element.

45. The computer-readable medium of claim 44, wherein said knowledge elements relate to a plurality of skills of the seller.

46. The computer-readable medium of claim 44, wherein said knowledge elements relate to an educational background of the seller.

47. The computer-readable medium of claim 44, wherein said knowledge elements relate to a certification of the seller.

48. The computer-readable medium of claim 44, wherein said knowledge elements relate to a work experience background of the seller.

49. The computer-readable medium of claim 44, wherein said knowledge elements relate to a plurality of skills, an educational background, a certification, and a work experience background of the seller.

50. The computer-readable medium of claim 44, further comprising the step of:
e) adjusting said overall rating in accordance with information provided by a third party service provider.

51. The computer-readable medium of claim 44, wherein said knowledge elements comprise a skill possessed by the seller, a role held by the seller or an industry knowledge possessed by the seller.

52. The computer-readable medium of claim 44, wherein said applying step c) comprises the step of:
c1) assessing near miss knowledge elements.

53. The computer-readable medium of claim 44, further comprising the step of:
e) adjusting said overall rating in accordance with a freshness education level.

54. The computer-readable medium of claim 44, further comprising the step of:
e) adjusting said overall rating in accordance a penalty measure that correlates to an accruement of missing buyer knowledge elements.
